(19) United States
(12) Patent Application Publication
(10) Pub. No.: US 2005/0003103 A1
(43) Pub. Date: Jan. 6, 2005

(54) Method for embedding a marking substance in a device such as an insertion tube

(76) Inventor: Robert J. Krupa, Leominster, MA (US)

Correspondence Address: Robert J. Krupa, 62 Indian Ridge Drive, Leominster, MA, 01453, US

(21) Appl. No.: 10/834,790

(22) Filed: Apr. 29, 2004

Related U.S. Application Data
(60) Provisional application No. 60/466,264, filed on Apr. 29, 2003.

(51) Int. Cl. B05D 5/12

(52) U.S. Cl. 427/558; 427/560

(57) ABSTRACT

A method of embedding a marking substance in an object to be marked, to create one or more visible markings on the object. A marking material is used to create one or more visible markings on the object. The marking material is placed on the surface of the object. A source of energy that is sufficient to cause the marking material to become embedded in the object is applied, to create one or more visible markings on the object.

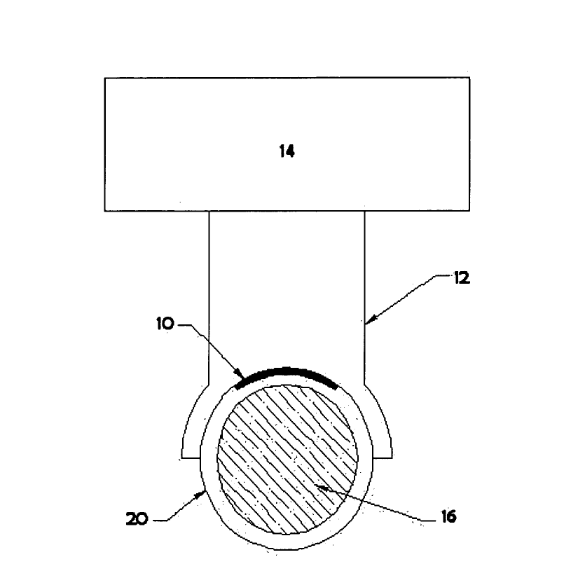

### CROSS REFERENCE TO RELATED APPLICATION

This application claims priority of Provisional application Ser. No. 60/466,264, filed on Apr. 29, 2003.

### FIELD OF THE INVENTION

This invention relates to a process for permanently marking devices such as endoscope insertion tubes.

### BACKGROUND OF THE INVENTION

In the fields of medical endoscopy, catheterization and ultrasound, it is often desirable or necessary to mark the exterior surface of the insertion tube, either an endoscope (visual, video, ultrasound, spectroscopic) or catheter, with length markers or other markings. This is done so the operator knows the depth the device has been inserted into the patient and the orientation of the device. There are a limited number of materials these tubes are manufactured from because of the biocompatibility or mechanical properties of these devices. It is often difficult to produce markings on these materials for a variety of reasons. One reason is that paints, epoxies, or other marking materials do not adhere well to the surface of the tube materials. Additionally, these tubes and their markings are subject to harsh chemical and high temperature sterilization environments, which cause an eventual removal or degradation of these markings. Abrasion, either during a procedure or during the cleaning and sterilization processes, also removes these markings from the tubes. Once the markings are removed or damaged, these devices must be replaced or repaired, often at considerable cost and down time.

Another difficulty arises because of the color of the tubes. Many insertion tubes employed for endoscopy are dark in color, typically black. Therefore, light-colored markings are preferred on these dark materials to produce a high contrast and easily readable marking. Laser marking these black materials produces gray or beige markings with relatively low contrast to the black insertion tube material.

### SUMMARY OF THE INVENTION

This invention relates to employing ultrasonic welding or laser radiation to embed a marking material into, or create a visible marking on, the surface of an insertion tube for remote monitoring or other operations, such as in an endoscope or catheter. Ultrasonic welding has been successfully used to bond together two similar materials. The ultrasonic process employs a mechanical vibration of the molecules within the two materials to be joined. The ultrasonic process also produces heat, which may aid in the commingling of the two materials. In a similar manner, laser marking, laser welding, and laser engraving produces localized heating and a commingling of the two materials subjected to the intense optical radiation. Laser marking may also involve material removal through ablation or evaporation, and can produce bleaching of photosensitive materials.

In one aspect of the invention, a marking material is applied to the surface of the insertion tube, and an ultrasonic device or laser is used to embed the marking material into the insertion tube material, commingling the two materials below the exterior surface of the tube. The result is a marking that is not simply a coating on the surface of the tube, but rather is an integral part of the tube material. This creates a more durable mark that is more resistant to abrasion and chemical degradation. Also, the marking material can be chosen such that it provides a high contrast to the color of the insertion tube or catheter material. The marking material may be any material that can be embedded into the surface of the tube. This can include such material as, but not limited to, lubricating coatings such as parylene, molybdenum disulphide, PTFE, and the like; or, pigments such as titanium dioxide (commonly used to color white paints); colored epoxy; or a material similar to the substrate but with a different, contrasting color. Insertion tubes are typically made of polyurethane, and an appropriate marking material can be a different color polyurethane or another organic polymer that can be embedded into polyurethane.

One skilled in the art can also extend this method of embedding a coating or marking material into material that is other than round tubing, such as rectangular or oval tubing, sheet material, and the like. Further, one skilled in the art can also readily see the applicability of this invention to devices other than devices that are intended for medical use.

The invention also has applications outside the medical field, where industrial endoscopes (borescopes, fiberscopes, and videoscopes) also utilize markings on the insertion portion of the endoscope to measure the insertion depth and/or to determine the scope's orientation.

### BRIEF DESCRIPTION OF THE DRAWING

Other objects, features and advantages will occur to those skilled in the art from the following description of the preferred embodiments, and the accompanying drawing, which is a schematic, cross-sectional diagram of an ultrasonic welding assembly being used to embed a marking, according to the invention.

### DETAILED DESCRIPTION OF THE PREFERRED EMBODIMENTS OF THE INVENTION

The preferred embodiment of the present invention is accomplished in a process in which a marking substance (such as titanium dioxide or other pigment materials, urethane, PTFE, paint, epoxy, and the like) is ultrasonically embedded into an insertion tube, preferably but not exclusively the (typically polyurethane) insertion tube of a medical device. See the attached figure. Markings 10 to be embedded in tube 20 are painted or silk screened onto the exterior of tube 20, and either allowed to cure, or alternatively, cured after the ultrasonic embedding process. An ultrasonic “horn” 12 of suitable shape to make intimate contact with at least the area of the tube that carries the marking is then placed over marking 10, while a suitably-shaped “anvil” 16 is placed within tube 20. Pressure is applied to the tube and marking by means of the anvil and horn being pressed together, with the marking therebetween. The vibration and heat produced by the ultrasonic wave produced by transducer 14 and exiting horn 12 impinge upon the marking and tube, causing the marking material's molecules to migrate into the tube material, and become embedded in the tube material. The process of ultrasonically embedding the marking material is best suited for similar materials, but should also work for materials that are somewhat like each other. Ideally, for endoscopes the substrate is polyurethane and the marking would be a polyurethane as well. This would form the best bond between the two components. However, the ultrasonic embedding process should also work for other organic polymers as well.

The shape of the horn is preferably the same as that of the outside of the tube if a specific marking has been laid down on the tube's surface (such as a line or stripe, a letter, or a number). Alternatively, if the marking material is laid down over a wide area, such as the entire outer surface of the tube, the horn can have a raised shape in the form of the desired marking (e.g., a letter, number, or line), similar to a metal stamp. For example, the marking material may be an uncured epoxy paint that is embedded into the substrate by the ultrasonic process. Once embedded, the epoxy is then cured by placing the tube and its markings in an oven at an elevated temperature.

Another embodiment of the invention involves placing a marking material on the surface of the tube and exposing selected areas of the marking material and tube to a focused laser beam. The marking material can be laid down over a large section of the tube, such as by spraying the tube's exterior surface with paint, epoxy, slurry of titanium dioxide, or similar suitable material. The marking material can also be applied to the exterior of the tube in the form of a thin sheet of material, such as a small piece of the marking material or a tube of material that encases the entire insertion tube (such as a cylinder of marking material that is heat shrunk over the tube's exterior surface). The sheet of marking material can be of the same type of material as the underlying tube to be marked, such as a thin sheet or tube of white polyurethane applied to the exterior of a black polyurethane insertion tube.

Once the marking material has been applied to the surface of the tube, a focused laser beam traces the marking design on the marking material and tube, heating the two materials. If sufficient heat is applied, the marking material and tube will fuse together, embedding a portion of the marking material into the insertion tube material. Once the laser has traced the marking and embedded the marking material into the insertion tube material, the remaining marking material can be removed by peeling (in the case of marking material that is in the form of a sheet or tube), or it can be removed by washing (in the case of a paint or pigment such as titanium dioxide).

Another embodiment of the invention involves placing a pigment within the substrate raw material, such as mixing titanium dioxide (a white pigment) or a photosensitive pigment with the substrate material prior to extrusion. This will evenly disperse the marking material within the substrate, but will not expose a significant portion of the marking material until acted upon by the marking laser. Laser marking this substrate will vaporize some of the substrate material, exposing the marking pigment. A photosensitive pigment can also be incorporated into the substrate material such that when exposed to the radiation of the laser light, it becomes white (or reflective).

Photosensitive materials include compounds that will change color when exposed to light. Ideally, this change will be from a darker to lighter color since typically a light marking is being created on a black endoscope tube. Photobleaching would be a specific case of photosensitive materials whereby the original color is lost, or changed to light, preferably white. For laser fusing, the same would hold true. For the laser photosensitive process, a black polyurethane tube, with the “black” provided by carbon black pigment, that also contains about 0.5% titanium dioxide, which is a white pigment. The laser radiation causes one or two things to happen: First, the heat can evaporate the polyurethane substrate and its carbon black pigment, exposing the white titanium dioxide, making the marking appear whiter by exposing the white and removing the “black.” Second, the laser light can “bleach” the polyurethane/carbon black, causing the “blackness” to appear more colorless, beige, or white.

Other embodiments will occur to those skilled in the art and are within the scope of the claims.

1. A method of embedding a marking substance in an object to be marked, to create one or more visible markings on the object, comprising:
providing an object to be marked;
providing a marking material that is to be used to create one or more visible markings on the object;
placing the marking material on the surface of the object; and
applying to at least the marking material on the surface of the object a source of energy that is sufficient to cause the marking material to become embedded in the object and create one or more visible markings on the object.

2. The method of claim 1, wherein the object is an insertion tube.

3. The method of claim 2, wherein the markings are tube insertion depth markings.

4. The method of claim 1, wherein the marking material comprises the same material as that of the object.

5. The method of claim 4, wherein the marking material is of a different color than that of the object.

6. The method of claim 1, wherein the marking material comprises a polymer.

7. The method of claim 1, wherein the marking material comprises a pigment.

8. The method of claim 1, wherein the source of energy is ultrasonic.

9. The method of claim 8, wherein the applying step comprises placing an ultrasonic horn against the marking material and placing an ultrasonic anvil against the object such that force can be applied to the marking material between the horn and the anvil.

10. The method of claim 9, wherein the applying step further comprises providing ultrasonic energy to the horn.

11. The method of claim 9, wherein the surface of the horn that is placed against the marking material has the same shape as the surface of the object on which the marking material was placed, to provide intimate contact between the horn and the object.

12. The method of claim 9, wherein the surface of the horn that is placed against the marking material defines the same shape as the marking, so that the horn creates the marking shape.

13. The method of claim 1, wherein the source of energy is a laser.

14. The method of claim 1, wherein placing a marking material on the surface of the object comprises spreading a fluid marking material on the surface of the object.

15. The method of claim 1, wherein placing a marking material on the surface of the object comprises placing a thin sheet of marking material on the object.

16. The method of claim 15, wherein the sheet encases the insertion tube.

17. The method of claim 16, wherein the sheet is heat-shrunk onto the insertion tube before the applying step.

18. The method of claim 1, wherein the applying step comprises tracing a pattern with a laser beam.

19. The method of claim 18, wherein the pattern is of the visible markings.

20. The method of claim 18, wherein the marking material absorbs the laser radiation.

21. A method of creating one or more visible markings of contrasting color in an object to be marked, comprising:
dispersing within the object to be marked a pigment material, wherein the pigment material has a different color than that of the raw material of the object; and
applying a laser beam to the object following a pattern of that of the visible markings being created, wherein the substrate material will thereby in part be vaporized, to thereby expose the pigment material, and create one or more visible markings in the object.

22. The method of claim 21, wherein the pigment material comprises titanium dioxide.

23. The method of claim 21, wherein the pigment material comprises a photosensitive pigment.

24. A method of embedding a marking substance in an object to be marked, to create one or more visible markings on the object, comprising:
providing an object to be marked;
providing a marking material that is to be used to create one or more visible markings on the object;
placing the marking material on the surface of the object;
placing an ultrasonic horn against the marking material;
placing an ultrasonic anvil against the object such that force can be applied to the marking material between the horn and the anvil;
wherein the surface of the horn that is placed against the marking has the same shape as the surface of the object on which the marking was placed, to provide intimate contact between the horn and the object; and
providing ultrasonic energy to the horn, to cause the marking material to become embedded in the object and create one or more visible markings on the object.

25. A method of embedding a marking substance in an object to be marked, to create one or more visible markings on the object, comprising:
providing an object to be marked;
providing a thin sheet of marking material that is to be used to create one or more visible markings on the object;
placing the thin sheet of marking material on the surface of the object; and
applying a laser beam to the marking material following a pattern of that of the visible markings being created, wherein the marking material absorbs the incident laser radiation and is thus heated thereby, to cause the marking material to become embedded in the object and create one or more visible markings on the object.
